(19) United States
(12) Patent Application Publication
(10) Pub. No.: US 2003/0173540 A1
(43) Pub. Date: Sep. 18, 2003

(54) Long persistent phosphor incorporated within a settable material

(76) Inventors: Bradford K Mortz, Cave Creek, AZ (US); Robert H Miller, Canton, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/149,466

(22) PCT Filed: Dec. 7, 2000
(86) PCT No.: PCT/US00/42694

(51) Int. Cl. C09K 11/02; C09K 11/08; C04B 14/36

(52) U.S. Cl. 252/301.36; 252/301.4 R; 252/301.6 S; 252/301.4 S; 106/712

(57) ABSTRACT

A process for incorporating a long persistent phosphor within a settable material includes firing a doped phosphor to obtain a phosphor having a persistence that ranges from minutes to hours. The fired phosphor is then ground into a phosphor particulate having a mean domain size. Typical particulate mean domain size ranges from 1 to 60 microns. The phosphor particulate is thereafter encapsulated within a water impervious coating material such as silicon oxide or fluoride. The coated phosphor particulate is then mixed in a specified volume ratio within the settable material while the settable material is in a pre-set state. Typical formulation ratios range from 0.1 to 30 volume percent of particulate. A method of forming a phosphorescent solid article is also disclosed.

### BACKGROUND OF THE INVENTION

1. Field of the Invention

The present invention relates generally to phosphorescent based materials and, more particularly, to a process and product by process for incorporating a long persistent phosphor within a settable material.

2. Description of the Prior Art

Various types of phosphor materials are well known in the art and which provide varying degrees of persistent luminescence. A common objective of phosphor materials is to provide an application for a luminescent light source which takes advantage of intermittent light irradiation and/or the absence of irradiating light on a continuous basis.

While the existence of phosphor materials such as above is fairly well known in the art, the recent trend has been to identify useful applications of persistent phosphor which will enable the production of production of sufficient light illumination following an iterative period of light irradiation.

### SUMMARY OF THE INVENTION

A process for incorporating a long persistent phosphor within a settable material includes firing a doped phosphor to obtain a phosphor having a persistence that ranges from minutes to hours. The fired phosphor is then ground into a phosphor particulate having a mean domain size. The phosphor particulate is thereafter encapsulated within a water impervious coating material. The coated phosphor particulate is then mixed in a specified volume ratio within the settable material while the settable material is in a pre-set state.

A phosphorescent settable formulation includes 0.1 to 30 volume percent of a long persistent doped sulfide phosphor particulate having a mean particle domain size of between 1 and 60 microns. The particulate has a water impervious silicon oxide or fluoride coating thereover A settable material carrier is provided for the particulate.

A method of forming a phosphorescent solid is also provided based upon setting of an inventive formulation.

### BRIEF DESCRIPTION OF THE DRAWINGS

Reference will now be made to the attached illustration, when read in combination with the following detailed description, wherein like reference numerals refer to like parts throughout the several views, and in which:

FIG. 1 is a schematic of the production of a settable host material incorporating the long persistent phosphor according to the present invention.

### DETAILED DESCRIPTION OF THE PREFERRED EMBODIMENTS

The present invention is a process, as well as a product produced by a process, for incorporating a long persistent phosphor within a settable host material. A significant number of different settable materials are capable of being utilized as carriers for the phosphorescent material and such settable materials are defined as constituted by a flowable liquid or semi-cured or semi-soft solid of some established viscosity. Without limitation, settable materials include gels, acrylic resins, epoxy resins, urethanes, polyalkylene resins polymeric monomers and oligomers, crosslinkable polymers, rubbers, and silicone resins. Other types of settable materials may include VOC polymer solutions, concrete, inks, paint formulations such as enamels, oil based, water based, latexes; water glass, caulk, putty, glues and adhesives, varnishes, plaster, nail polish, and lacquers. It is appreciated that the settable carrier materials of the present invention are amenable to the addition of optional additives illustratively including catalysts, fillers, plasticizers, solvent, thickeners, and pigments.

The long persistent phosphorescent material is constituted by any of a number of various chemical compositions as are known in the art. As used herein “long persistence” is defined to mean a phosphorescence lifetime greater than 1 minute. The phosphor is typically provided as a powderized or granulate material and, in one instance, may include a lime green phosphor produced under the commercial name Nemoto Luminova and consisting of a strontium aluminate material. Additional Luminova colors include blue and which is constituted by a recipe of a Calcium Strontium Aluminate, and which is doped with Europium.

Other phosphors may specifically include a strontium sulfide material which is fired in an inert crucible at a selected elevated temperature and for a determined time period. To achieve the desired level of long persistence as well as a given color, a dopant is added to the phosphor. While dopant precursors are typically slurried with phosphor precursors prior to firing, it is appreciated that dopants are also intercalated into a phosphor through exposing a fired phosphor to a dopant. Post firing dopant addition illustratively occurs through solution surface coating or ion implantation. Experimentation of different dopants has determined that a Europium dopant will achieve a persistent phosphor having an orange/red color. Dopants are typically present from 0.1 to 5 atomic percent. Often it is desirous to include a second dopant to enhance persistence lifetimes or modify phosphor color. As is also well known in the art, additional types of dopants may include alumina, lanthanide oxides, fluorides and chlorides and are capable of yielding persistent phosphors having pale yellow and purple shades. Further, the use of varying percentages of Calcium with Strontium Sulfide will achieve additional color shades leading to a purer red color.

Following the crucible firing of the doped phosphor, the persistent phosphor composition is dried and is retrieved in a rock-like form. A subsequent crushing and grinding operation reduces the particle domain size to a preferred range of 1 to 60 microns. More preferably, the particle mean domain size is from 1 to 45 microns. Certain paint or solvent based applications require particular sizes to be reduced to, in some instances, down to 1 micron in size. Prior to introducing the phosphorescent particles into a host material, it is desirable to coat or encapsulate them so as to ensure its long term performance. It has been found that moisture, over time, tends to degrade the ability of the phosphor to maintain its long-term performance.

Accordingly, one or more types of encapsulation techniques are employed to coat the individual phosphor granulates. A first type of encapsulation is provided by a silicon oxide applied during a firing temperature of 800° C. A fluoride material may be applied contemporaneously with or separately from the silicon oxide. Typically, a firing temperature of approximately 700° C. is best suited for application of fluoride. Other encapsulation techniques may employ organic chlorosilanes in hexane or heptane solvents. The process steps in which the encapsulation of the material is accomplished typically includes mixing the coating powder with the substrate powder in an appropriate ratio, firing the mixed powder at the prescribed temperature for a defined time, washing the fired powder to remove the uncoated portion of the core powder, and drying the washed powder. Additional encapsulation techniques are illustratively detailed in U.S. Pat. Nos. 4,710,674; 5,049,408; 5,196,229; 5,118,529; 5,113,118 and 5,220,341.

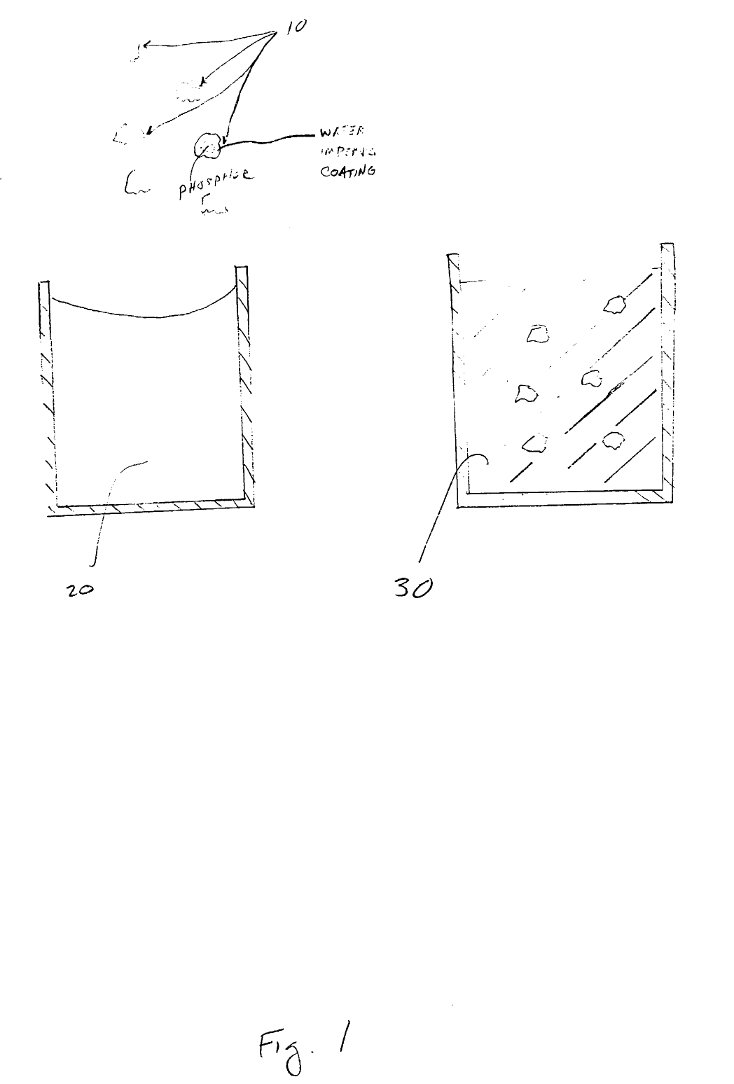

With reference again to the list of settable materials previously recited, as well as to FIG. 1, the encapsulated phosphor particulate is illustrated at 10. The encapsulated long persistent phosphor is mixed during the manufacture stage of the settable host material 20 at a desired ratio by weight. Although not clearly illustrated in FIG. 1, it is desirable to congregate the phosphorescent material towards the surface layers of some settable host materials. The effect of this is to reduce the volume of the fairly expensive to produce phosphor which is needed to provide the desired illuminating effect. Consistent with this goal, it is further desirable that the phosphor granulate possess isopycnic characteristics so that they are capable of being suspended within the host material. Accordingly, the phosphorescent particulate is incorporated into the host material during its fluidic or semi-fluidic states. Encapsulation of the phosphor particulates permits them to maintain their long persistent and rechargeable characteristics during the setting stage of the host material, as well as during subsequent use and exposure to the environment. The settable material 20 upon application of the encapsulated particulate 10 results in a solution or suspension 30 suitable for application to a variety of substrates. It is appreciated that a settable material suspension or solution 30 according to the present invention is operative with other settable materials, suspensions or solutions containing encapsulated particulate applied in a step-wise fashion. Thus, by way of example, a base coating applied to a substrate is devoid or deficient in encapsulated phosphor relative to a subsequently applied top coat, thereby enhancing the phosphorescence per unit area of substrate for a given quantity of encapsulated phosphor.

In a first application the encapsulated phosphorescent powder is incorporated within a host material such as a nail polish formulation. As was previously described, it is desirous to vary the percentage by weight of the phosphor powder relative to that of the host material and, in the instance of a clear nail polish, 1 to 30% by volume phosphor in the formulation is operative, with a mixture of 15% by volume of phosphor within the vial of nail polish has been found to be optimal for forming a long persistent and rechargeable application. Tests on selected phosphors have yielded several uninterrupted hours of long persistent glow.

A further application of a long persistent phosphor involves mixing within a wax candle so as to provide a soft long persistent glow. Recharging of the phosphor is continuously maintained by the effect of the lit flaming end. Phosphors are typically present from 0.1 to 20% by volume in a candle wax according to the present invention.

A yet further application involves an encapsulated long persistent phosphor incorporated into a ceramic/silicate material such as a brick paver or specialty cement. In the preferred embodiment, the phosphor is added into the top one inch of the cementitious mixture during its semi-solid or slurry stage at typically between 0.1 and 20 volume percent. This permits the phosphor to intermix freely with the top surface layers of the paver blocks and, as previously discussed, thereby diminishing the need of incorporating a greater volume by weight of phosphor throughout the entire thicknesses of the pavers, including portions or surfaces which are never exposed in use. In an alternative variant, a settable paint material can be employed to sufficiently coat the surface of the paver bricks.

Any patents mentioned in the specification are indicative of the levels of those skilled in the art to which the invention pertains. These patents are herein incorporated by reference to the same extent as if each individual patent was specifically and individually incorporated by reference.

Having described our invention, it will become apparent that it teaches a novel and useful process and product by process for incorporating a long persistent phosphor, such as in a particulate form, within a settable host material. Many and numerous additional embodiments will become apparent to those skilled in the art to which it pertains without deviating from the scope of the appended claims.

We claim:

1. A process for incorporating a long persistent phosphor within a settable material, comprising the steps of:
firing a doped phosphor;
grinding said doped phosphor into a phosphor particulate having a mean domain size;
encapsulating said phosphor particulate within a water impervious coating material; and
mixing a specified volume ratio of said encapsulated phosphor particulates within the settable material during a pre-set.

2. The process according to claim 1, wherein said phosphor is Strontium Sulfide with a Europium dopant.

3. The process according to claim 1, wherein said phosphor is a mixed Calcium Strontium Sulfide.

4. The process according to claim 1, wherein said phosphor particulate is encapsulated within a fluoride coating.

5. The process according to claim 1, wherein said phosphor particulate is encapsulated within a silicon oxide coating.

6. The process according to claim 1, wherein said phosphor particulate is ground to a mean domain size of 30 to 60 microns.

7. The process according to claim 1 further comprising the step of:
setting said settable material to form a phosphorescent solid.

8. A phosphorescent settable formulation comprising:
0.1 to 30 volume percent of a long persistent doped sulfide phosphor particulate having a mean particle domain size of between 1 and 60 microns, said particulate having a water impervious coating thereover selected from the group consisting of: silicon oxide and fluoride; and
a settable material carrier for said particulate.

9. The formulation according to claim 8 wherein said particulate is present from 5 to 20 volume percent.

10. The formulation according to claim 8 wherein said particulate is present from 10 to 20 volume percent.

11. The formulation according to claim 8 wherein said particulate is strontium sulfide doped with europium.

12. The formulation according to claim 11 further comprising a second lanthanide dopant.

13. The formulation according to claim 8 wherein the mean particle domain size of between 1 and 45 microns.

14. The formulation according to claim 8 wherein said settable material carrier is selected from the group consisting of: gel, acrylic resin, epoxy resin, polymeric monomers, polymeric oligomers, crosslinkable polymers, silicone resins, rubbers, concrete, latexes, water glass, solvated polymers, paints, caulks, plaster, lacquer and varnish.

15. A formulation of claim 1 obtainable by the process of claim 8.

16. A method of rendering an solid article phosphorescent which method comprises setting a formulation of claims 8 to 14.

17. The method of claim 16 further comprising: applying said formulation to a substrate.

18. The method of claim 16 wherein said formulation is set such that said article is free-standing.
